(19) United States
(12) Patent Application Publication
(10) Pub. No.: US 2008/0030888 A1
(43) Pub. Date: Feb. 7, 2008

(54) TRANSDUCER FLY HEIGHT DISTRIBUTION RANGE REDUCTION

(75) Inventors: DON BRUNNETT, Pleasanton, CA (US); Jingbo Yu, San Jose, CA (US); Pang L. Tan, Fremont, CA (US)

Correspondence Address: Randall K. McCarthy;Fellers, Snider, Blankenship, Bailey & Tippens, PC, 100 North Broadway, Suite 1700, Oklahoma City, OK, 73102-8820, US

(73) Assignee: Maxtor Corporate, Scotts Valley, CA (US)

(21) Appl. No.: 11/751,940

(22) Filed: May 22, 2007

Related U.S. Application Data
(60) Provisional application No. 60/747,907, filed on May 22, 2006.

(51) Int. Cl. G11B 21/21

(52) U.S. Cl. 360/75

(57) ABSTRACT

Preferred embodiments of the present invention are generally directed to reducing variation in a distribution of transducer fly heights by selectively applying first and second fly height adjustment values to a plurality of transducers, the second fly height adjustment value being a multiple of the first fly height adjustment value.

### RELATED APPLICATIONS

The present application makes a claim of domestic priority to U.S. Provisional Patent Application No. 60/747,907 filed May 22, 2006.

### BACKGROUND

The present case is generally directed to transducer fly height control, and more particularly, to reductions in a transducer fly height distribution range. Some data storage devices, such as hard disc drives, use radially movable data transducers to access data tracks on media recording surfaces to carry out data I/O operations with a host device. The transducers are often hydrodynamically supported in close proximity to the surfaces by fluidic (e.g., air) currents established by high speed rotation of the media.

The continued demand for devices with increased data storage densities has generally led to the development of a number of fly height adjustment capabilities that can be enacted during device operation. For example, in some designs the fly height of a selected transducer can be individually tuned to maintain a desired clearance adjacent the associated medium during a data I/O operation.

Global fly height adjustment capabilities have also been proposed whereby a common amount of fly height adjustment is applied across the board to multiple transducers in a given device. This latter technique can be useful, for example, during a ramp unload operation in which the transducers are moved from the media surfaces and parked on a ramp structure during a device deactivation sequence.

### SUMMARY

Preferred embodiments of the present invention are generally directed to reducing variation in a distribution of transducer fly heights by selectively applying first and second fly height adjustment values to a plurality of transducers, the second fly height adjustment value being a multiple of the first fly height adjustment value.

In some preferred embodiments, a method comprises selecting a first fly height adjustment value in relation to a first distribution of fly heights of a plurality of transducers; determining a second fly height adjustment value as a multiple of the first fly height adjustment value; and selectively applying the first and second fly height adjustment values to the plurality of transducers to form a second distribution of fly heights with an overall range less than an overall range of the first distribution.

In other preferred embodiments, an apparatus comprises a controller configured to select a first fly height adjustment value in relation to a first distribution of fly heights of a plurality of transducers, to determine a second fly height adjustment value as a multiple of the first fly height adjustment value, and to selectively apply the first and second fly height adjustment values to the plurality of transducers to form a second distribution of fly heights with an overall range less than an overall range of the first distribution.

In further preferred embodiments, an apparatus comprises a plurality of transducers with a first distribution of fly heights with respect to a corresponding plurality of media surfaces; and a controller which generates a second distribution of fly heights for the plurality of transducers with an overall range less than an overall range of the first distribution by selectively applying a first fly height adjustment value to a selected portion of said plurality of transducers and a second fly height adjustment value equal to twice the first fly height adjustment value to the remaining portion of said plurality of transducers.

### BRIEF DESCRIPTION OF THE DRAWINGS

FIG. 1 shows an exemplary data storage device.

FIG. 2 provides a functional block diagram of a servo circuit of the device of FIG. 1.

FIG. 3 generally illustrates exemplary final servo data on a storage medium of the device.

FIG. 4 shows an exemplary initial servo spiral pattern used as a reference during the writing of the final servo data of FIG. 3.

FIG. 5 generally provides a schematic depiction of a selected transducer of the device of FIG. 1.

FIG. 6 is a functional representation of selected portions of the servo circuit of FIG. 2.

FIG. 7 is a flow chart for a FLY HEIGHT PROCESSING routine, generally illustrative of steps carried out in accordance with various embodiments of the present invention to control fly height in a system such as the device of FIG. 1.

FIG. 8 shows respective exemplary fly height distributions achieved during the routine of FIG. 7.

FIG. 9 shows additional exemplary fly height distributions achieved during the routine of FIG. 7.

### DETAILED DESCRIPTION

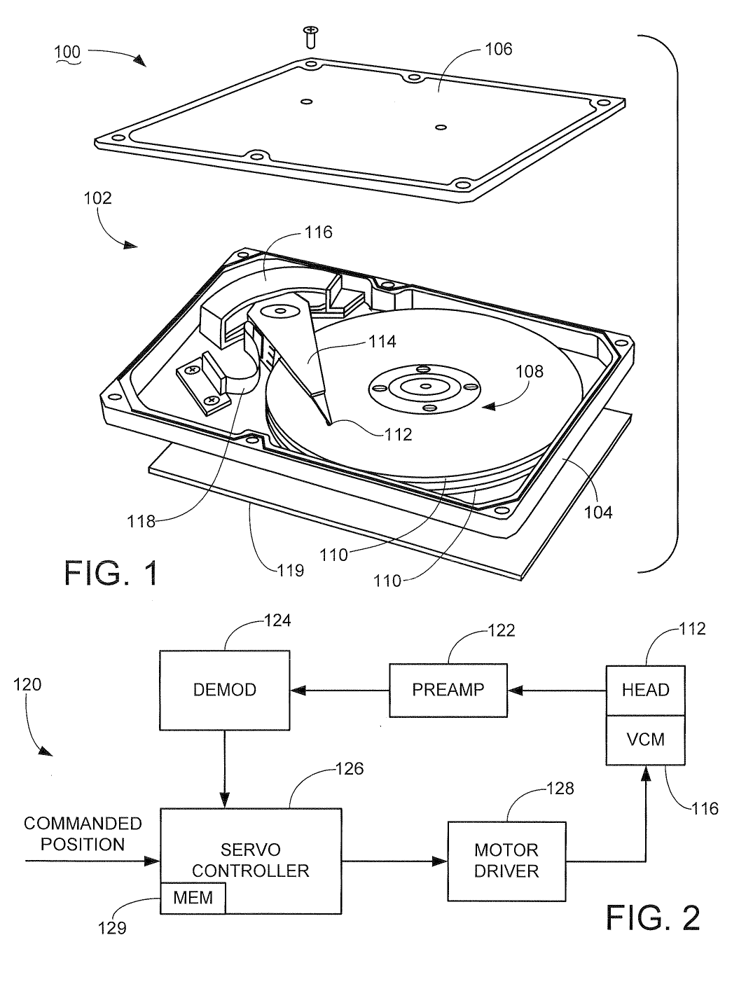

FIG. 1 generally illustrates a data storage device 100 to provide an exemplary environment in which various embodiments of the present invention can be advantageously practiced. The device 100 includes a housing 102 formed from a base deck 104 and top cover 106. An internally disposed spindle motor 108 is configured to rotate a number of storage media 110.

An array of read/write transducers (heads) 112 are supported adjacent the associated media surfaces by fluidic (e.g., air) currents established by the high speed rotation of the media 110. The transducers 112 access data tracks defined on the media surfaces to transfer data between the media 110 and a host device.

An actuator 114 moves the transducers 112 through application of current to a voice coil motor (VCM) 116. A flex circuit assembly 118 provides electrical communication paths between the actuator 112 and device control electronics on an externally disposed printed circuit board (PCB) 119.

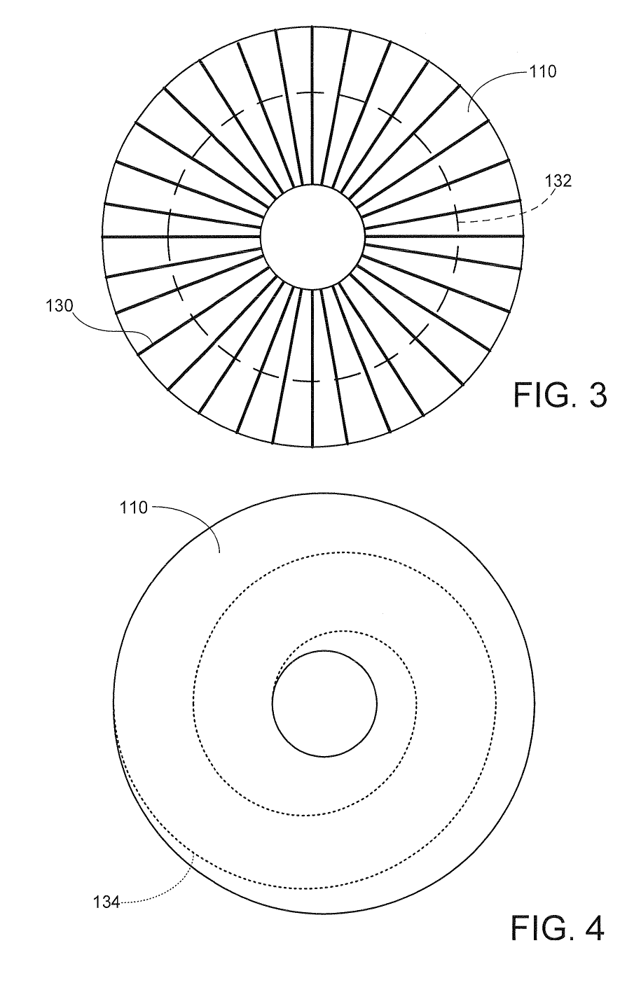

FIG. 2 provides a generalized functional block diagram for a closed loop servo control circuit 120 of the device 100. Embedded servo data are transduced from the media 110 by a selected transducer 112 and provided to a preamplifier (preamp) circuit 122. The preamp circuit 122 preamplifies and filters the readback signals from the transducer 112, and provides the processed servo data to a demodulation (demod) circuit 124.

The demod circuit 124 detects and conditions the servo data, including application of automatic gain control (AGC) and conversion of the signals to digital form. A servo controller 126 processes the digitized servo data to generate a current command signal that is supplied to a motor driver circuit 128. In response, the driver circuit 128 applies the appropriate current to the VCM 116 to position the transducer 112.

The servo controller 126 is preferably characterized as a programmable processor with associated servo code in memory 129 to direct the operation of the servo loop, although the controller can take other forms including being partially or fully realized in hardware. The controller 126 generally operates in two primary modes, seeking and track following. Seeking generally involves controlled movement of the selected transducer 112 from an initial track to a destination track. Track following generally comprises operation of the controller 126 to maintain the selected transducer 112 over the center (or other commanded position) a selected track in order to carry out data I/O operations with the track.

The embedded servo data are arranged on each recording surface as shown in FIG. 3. A series of spaced apart servo wedges 130 contiguously extend like spokes of a wheel from an outermost diameter (OD) to an innermost diameter (ID) of the recording surface. The servo wedges 130 define adjacent concentric servo data tracks on the media, such as generally represented at 132.

Each servo wedge 130 preferably includes synchronization, automatic gain control (AGC), header, track address (e.g., Grey code), and intra-track positional information (e.g., A-F dibit patterns). These respective fields are demodulated by the servo circuit 120 to control the positioning of the transducer 112 during I/O operations with user data sectors in the regions between adjacent servo wedges 130. The total number of servo wedges 130 will be selected in accordance with the requirements of a given application, and may be on the order of around 200 or more.

In accordance with various embodiments, the final servo data shown in FIG. 3 are written during a self-servo write operation of the device 100. Coarse servo data are initially written to the media surfaces, such as exemplary servo spiral 134 in FIG. 4, and the coarse servo data serve as a prewritten reference for the placement of the final servo data.

The servo spiral 134 continuously extends from OD to ID, and can be written by the device itself or in conjunction with a servo track writer (STW) mechanism coupled to the device (not shown). The spiral 134 can also be provided to the media surface prior to installation of the medium 110 into the device, such as by way of a multi-disc writer (MDW) or printing process.

While only a single spiral is shown in FIG. 4, it is contemplated that a population of such spirals will be arranged in spaced apart fashion around the medium, with the total number of spirals preferably equal to or greater than the total number of final servo wedges 130. Other forms of prewritten reference can be used as well, or can be omitted entirely. The coarse servo data are preferably provided to a single surface in the media stack, although such is not necessarily required; in other embodiments the coarse servo data are provided to multiple selected surfaces, or even all of the surfaces in the media stack.

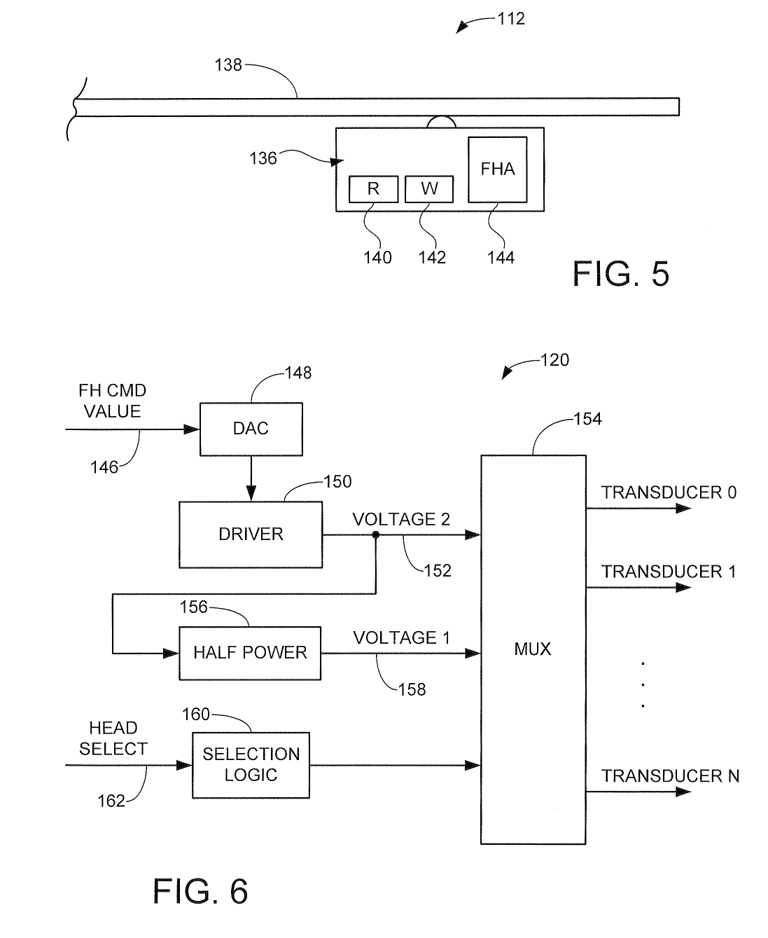

FIG. 5 is a schematic representation of a selected transducer 112 from the device of FIG. 1. The transducer 112 is shown to include a slider structure 136 adapted to hydrodynamically interact with fluidic currents established by high speed media rotation to nominally sustain the transducer at a selected fly height proximate the media surface. The slider 136 is gimbaled for multi-axial movement at a distal end of a flexure (suspension) assembly 138 of the actuator 114 (FIG. 1).

The slider structure 136 supports separate read (R) and write (W) elements 140, 142, used during read and write operations, respectively. It is contemplated that the read element 140 comprises a magneto-resistive (MR) sensor and the write element 142 comprises a perpendicular recording coil and flux core structure.

A fly height adjustment (FHA) block 144 is configured to operatively adjust the fly height of the transducer 112 during operation. The FHA 144 can take any number of well known configurations, such as a heater member, a piezoelectric transducer, a magneto-striction element, etc.

Generally, it is contemplated that the FHA 144 adjusts the fly height of the transducer 112 in relation to a magnitude of a received control signal (e.g., an applied voltage, etc.). In the present example it is contemplated that activation of the FHA 144 will result in a reduction (lowering) of the transducer fly height, and subsequent deactivation of the FHA 144 will cause the transducer 112 to resume a normal, higher fly height. Such is not necessarily limiting, however.

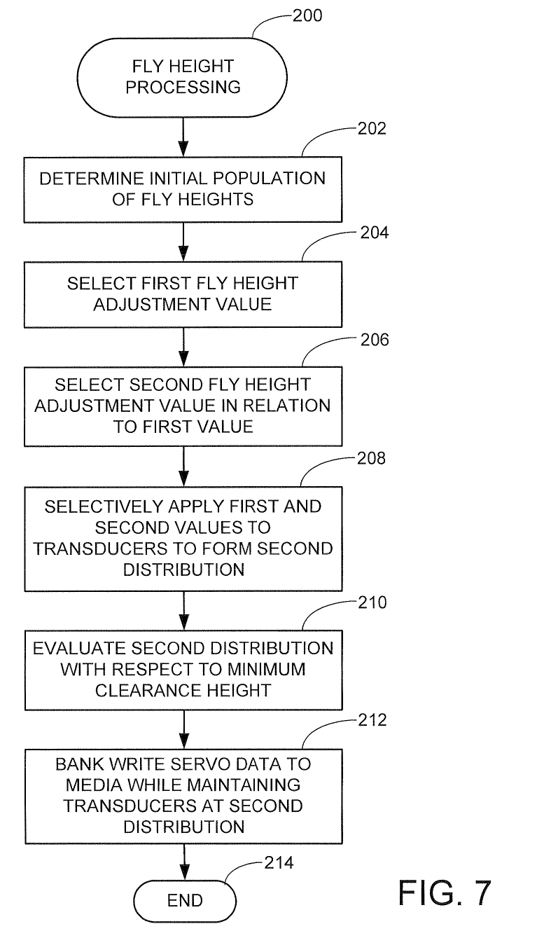

FIG. 6 sets forth relevant portions of the aforedescribed servo circuit 120 of FIG. 2. The circuitry represented in FIG. 6 is preferably incorporated into the preamp 122 and is utilized, as explained below, to adaptively adjust a fly height population distribution of the device 100.

A fly height command value is initially supplied via path 146 by the servo controller 126. The command value is a multi-bit digital value indicative of a desired fly height adjustment to be applied to one or more of the transducers 112. The command value is processed by a digital to analog converter (DAC) 148 which provides a corresponding analog voltage to a driver circuit 150.

The driver circuit 150 outputs a control voltage (VOLTAGE 2) on path 152. The VOLTAGE 2 control voltage is supplied to a multiplexer (mux) 154, as well as to a half power reduction circuit 156. The reduction circuit 156 outputs another control voltage (VOLTAGE 1) on path 158, and this VOLTAGE 1 control voltage is also supplied to the mux 154.

VOLTAGE 2 can be any selected multiple of VOLTAGE 1, such as but not limited to VOLTAGE 2=(1/2)(VOLTAGE 1); in this latter case, VOLTAGE 1 is referred to as a “half power” level and VOLTAGE 2 is referred to as a “full power” level. The respective VOLTAGE 1 and VOLTAGE 2 values are referred to herein as first and second fly height adjustment values, respectively.

A head selection logic block 160 receives a multi-bit head select command from the servo controller 126 on path 162 to provide an associated selection input to the mux 154. In response, the mux 154 operates to selectively apply the first and second fly height adjustment values to a plurality of transducers (TRANSDUCER 0 to TRANSDUCER N).

It is contemplated that each of the plurality of transducers incorporates a heating element as part of the associated FHA 144 (FIG. 5), and the cyclical switching of the respective adjustment values by the mux 154 achieves a steady state fly height adjustment in relation to the associated fly height adjustment value (e.g., VOLTAGE 1 or VOLTAGE 2). Other arrangements can be utilized, however, including arrangements that continuously apply the associated fly height adjustment value(s) to the associated transducer(s).

FIG. 7 sets forth a FLY HEIGHT PROCESSING routine 200, generally illustrative of steps carried out in accordance with various embodiments. While not limiting, it is contemplated that the routine 200 is performed by the servo circuit 120 of FIG. 2 to adaptively adjust the fly heights of the transducers 112 during the bulk writing of the final servo data wedges 130 of FIG. 3 to the media surfaces (FIG. 1).

An initial distribution of fly heights of the transducers 112 is first determined at step 202. This initial distribution represents an accumulation of the individual nominal fly heights, or clearance distances, of the transducers 112 above the associated media surfaces under then-existing steady state conditions (i.e., non-FHA assisted fly heights).

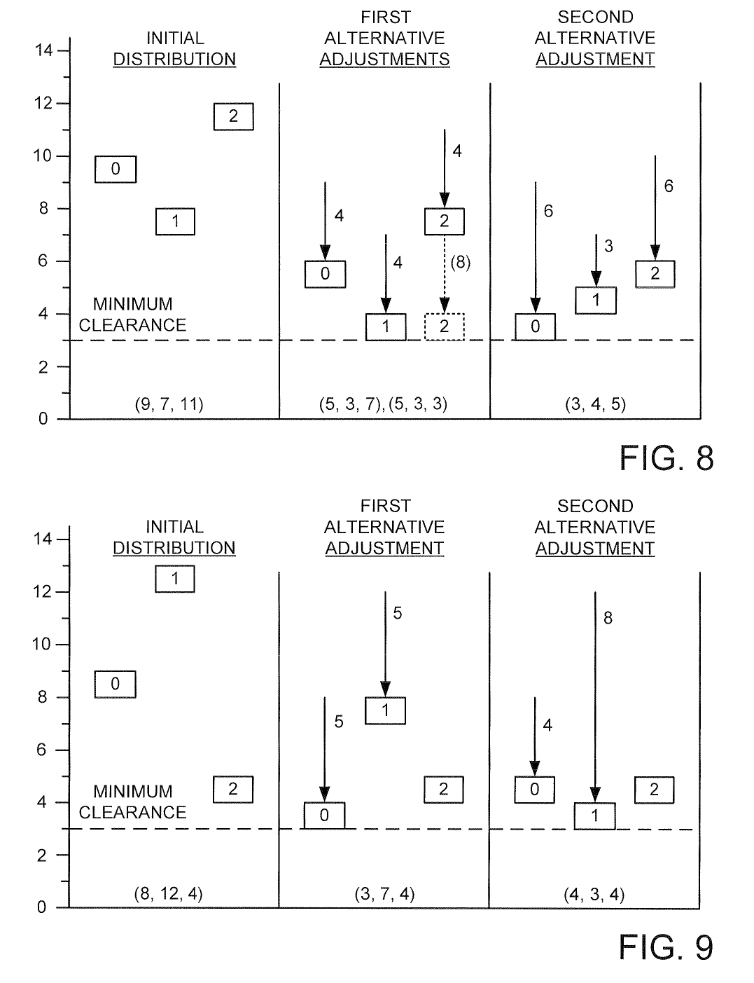

An exemplary initial distribution is graphically represented in FIG. 8. More specifically, the left-most side of FIG. 8 shows initial fly heights for three exemplary transducers 0, 1 and 2. The associated initial fly heights are given as 9 nanometers, nm (10⁻⁹ meters), 7 nm and 11 nm. The initial distribution can thus be expressed as (9, 7, 11), with an average value of 9 nm ([9+7+11]/3) and an overall range of 4 nm (11−7=4).

For reference, FIG. 8 also shows a minimum clearance value of 3 nm, which represents a specified minimum fly height distance for the transducers 0, 1, 2. It is contemplated that each transducer will perform optimally when it is positioned as close as possible to the minimum clearance, but not lower. Conversely, degraded performance is generally achieved the farther away the transducer is from the minimum clearance value.

The initial distribution determined during step 202 of FIG. 7 can be obtained in a number of ways. In some embodiments, the circuitry of FIG. 6 is used to evaluate the nominal fly height of each transducer 112 in turn. For example, this can involve writing an initial pattern to the medium 110 and evaluating characteristics thereof (field strength, radial width, etc.) to estimate the nominal fly height.

Alternatively or additionally, incrementally larger fly height adjustment values can be successively applied to the selected transducer until the minimum clearance value is reached. The magnitude of the final applied fly height adjustment value will generally indicate the initial, nominal value. For example, assume that the application of a fly height adjustment value corresponding to 6 nm of deflection is found to provide optimum write performance by transducer 0. From this it readily follows that transducer 0 has a nominal fly height of 9 nm (i.e., 6+3=9).

Continuing with the routine of FIG. 7, a first fly height adjustment value is selected at step 204. As explained below, the first fly height adjustment value preferably corresponds to a selected reduced control voltage level of FIG. 6 (e.g., the half power value VOLTAGE 1). Adaptive adjustment of this value may be necessary.

Initially, the first fly height adjustment value is preferably selected in relation to the difference between the smallest (lowest) fly height in the initial distribution and the minimum clearance value. In the example of FIG. 8, these correspond to the fly height of 7 nm of transducer 1, and the minimum clearance of 3 nm. A simple difference between these two values is 4 nm (7−3=4).

A second fly height adjustment value is next selected in FIG. 7 at step 206. The second fly height adjustment value is selected as a multiple of the first fly height adjustment value of step 204, such as the full power value VOLTAGE 2 of FIG. 6.

At step 208, the first and second fly height adjustment values of steps 204, 206 are next applied to the respective transducers and the resulting fly height distribution is evaluated. This is exemplified by the middle section of FIG. 8, which shows an initial global adjustment of 4 nm to each of the transducers 0, 1, 2 in accordance with the first fly height adjustment value. This provides a fly height distribution of (5, 3, 7).

Preferably, step 208 continues with a determination as to whether the second fly height value can be applied to any of the transducers to further improve the second distribution. In the example of FIG. 8, the answer is yes. That is, as shown in broken line fashion, there is sufficient room to apply the full power second fly height adjustment value of 8 nm to transducer 2, which further reduces the fly height of transducer 2 from 7 nm to 3 nm.

The higher adjustment value of 8 nm cannot be applied to transducer 0, however, as this would result in a lower than acceptable fly height of 1 nm. Nevertheless, the operation of step 208 provides a significantly improved distribution of (5, 3, 3), with an average fly height value of 3.67 nm and an overall range of 2 nm.

Continuing with the flow of FIG. 7, at step 210 the second distribution is further evaluated to determine whether further adjustments may be made to the first and second fly height adjustment values. For example, as shown by the right-hand portion of FIG. 8, the use of a first fly height adjustment value of 3 and a second fly height adjustment value of 6 results in an alternative distribution of (3, 4, 5) for the transducers 0, 1, 2. This latter distribution provides a slightly higher average value of 4 nm, and retains the same overall range of 2 nm.

There may be reasons why the (3, 4, 5) distribution on the left-hand side of FIG. 8 is preferable over the (5, 3, 3) distribution in the middle portion of FIG. 8. For example, it may be desirable that transducer 0 be brought as close as practical to the associated media surface, leading to the decision to use the (3, 4, 5) distribution in lieu of the (5, 3, 3) distribution. Nonetheless, step 210 provides a desirable amount of flexibility in selecting the final distribution characteristics suitable to a given situation.

Finally, at step 212 in FIG. 7, the routine preferably operates to bank write the final servo data to the respective media surfaces while maintaining the transducers at the finally selected second distribution. While this step is optional, when carried out this step preferably involves servoing off of the coarse servo data (FIG. 4) using one of the selected transducers (e.g., transducer 0), while simultaneously issuing write currents to all of the transducers 0, 1, 2 to write the servo data on all of the media surfaces at the same time. This saves processing time, as well as improves surface-to-surface alignment of the resulting servo data. The routine then ends at step 214.

Another illustrative example of the operation of the routine of FIG. 7 is set forth in FIG. 9. In FIG. 9, a second set of transducers 0, 1, 2 are found to have an initial fly height distribution of (8, 12, 4). Generally speaking, this initial distribution can be considered “worse” than that of FIG. 8, in that the average fly height value is 8 nm and the overall range is also 8 nm. This is true even though transducer 2 exhibits a nominally acceptable initial fly height of 4 nm, which may not require further adjustment.

An initial first fly height adjustment value can thus be selected based on the second closest transducer, which in this case is transducer 0. Using a first fly height adjustment value of 5 nm results in a first alternative distribution of (3, 7, 4); that is, an adjustment of 5 nm brings transducer 0 to the minimum clearance of 3 nm, but unacceptably leaves transducer 1 at a fly height of 7 nm. The full power adjustment value of 10 nm cannot be applied to transducer 1, as this would result in a fly height of 2 nm.

However, reducing the first fly height adjustment value from 5 nm to 4 nm correspondingly reduces the second fly height adjustment value from 10 nm to 8 nm, and results in an improved distribution of (4, 3, 4). Hence, even with significantly large amounts of variation in the initial distribution, one or more final distribution solutions will be available that provide a reduced overall range proximate the minimum fly height clearance value.

It will be understood that even though numerous characteristics and advantages of various embodiments of the invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
selecting a first fly height adjustment value in relation to a first distribution of fly heights of a plurality of transducers;
determining a second fly height adjustment value as a multiple of the first fly height adjustment value; and
selectively applying the first and second fly height adjustment values to the plurality of transducers to form a second distribution of fly heights with an overall range less than an overall range of the first distribution.

2. The method of claim 1, further comprising simultaneously applying write signals to each of the plurality of transducers to write data to a corresponding plurality of media surfaces during the selectively applying step.

3. The method of claim 1, wherein the selecting step comprises identifying the transducer from said plurality with the smallest fly height in the first distribution, and selecting the first fly height adjustment value in relation to said smallest fly height.

4. The method of claim 1, wherein the second fly height adjustment value is nominally equal to twice the first fly height adjustment value.

5. The method of claim 1, wherein the second distribution has a smallest fly height at or above a minimum clearance distance.

6. The method of claim 1, wherein the plurality of transducers comprises a first transducer and a second transducer, wherein the first transducer has the smallest fly height in the first distribution, and wherein the second transducer has the smallest fly height in the second distribution.

7. The method of claim 1, wherein the plurality of transducers are coupled to a common actuator adjacent a stack of media surfaces.

8. The method of claim 1, wherein the selectively applying step comprises applying a single multi-bit digital value to a preamplifier circuit to generate the first and second fly height adjustment values.

9. The method of claim 8, wherein the single multi-bit digital value has a magnitude indicative of the second fly height adjustment value, and wherein the preamplifier circuit uses a voltage reduction circuit to generate the first fly height adjustment value in relation to a voltage of the second fly height adjustment value.

10. The method of claim 1, wherein the selecting, determining and selectively applying steps are carried out by a controller of a data storage device during a self servo-write operation in which servo data are bank written to a plurality of media surfaces of the data storage device.

11. An apparatus comprising a controller configured to select a first fly height adjustment value in relation to a first distribution of fly heights of a plurality of transducers, to determine a second fly height adjustment value as a multiple of the first fly height adjustment value, and to selectively apply the first and second fly height adjustment values to the plurality of transducers to form a second distribution of fly heights with an overall range less than an overall range of the first distribution.

12. The apparatus of claim 11, wherein the controller is further configured to direct the simultaneously application of write signals to each of the plurality of transducers to write data to a corresponding plurality of media surfaces while the transducers are maintained at the second distribution of fly heights.

13. The apparatus of claim 11, wherein the controller selects the first fly height adjustment value in relation to the smallest fly height in the first distribution.

14. The apparatus of claim 11, further comprising an actuator which supports the plurality of transducers adjacent a stack of media surfaces.

15. The apparatus of claim 14, further comprising a preamplifier circuit coupled between the controller and the transducers, wherein the controller applies a single multi-bit digital value to a digital to analog converter (DAC) of the preamplifier circuit to generate the first and second fly height adjustment values.

16. The apparatus of claim 15, wherein the preamplifier circuit further comprises a voltage reduction circuit to generate the first fly height adjustment value in relation to a voltage of the second fly height adjustment value.

17. The apparatus of claim 11, wherein the second fly height adjustment value is nominally equal to twice the first fly height adjustment value.

18. An apparatus comprising:
a plurality of transducers with a first distribution of fly heights with respect to a corresponding plurality of media surfaces; and
a controller which generates a second distribution of fly heights for the plurality of transducers with an overall range less than an overall range of the first distribution by selectively applying a first fly height adjustment value to a selected portion of said plurality of transducers and a second fly height adjustment value equal to twice the first fly height adjustment value to the remaining portion of said plurality of transducers.

19. The apparatus of claim 18, further comprising a preamplifier circuit coupled between the plurality of transducers and the controller, wherein the controller applies a single multi-bit value to the preamplifier circuit to generate said first and second fly height adjustment values.

20. The apparatus of claim 18, wherein the controller further directs the writing of servo data to each of a plurality of media surfaces while maintaining the plurality of transducers at said second distribution.
